(19) United States
(12) Patent Application Publication
(10) Pub. No.: US 2007/0178862 A1
(43) Pub. Date: Aug. 2, 2007

(54) Weight Training For Antenna Array Beam Patterns in FDD/TDMA Terminals

(75) Inventors: Jack Winters, Middletown, NJ (US); James June-Ming Wang, San Marino, CA (US)

Correspondence Address: PATENTRY, P.O. BOX 151616, SAN RAFAEL, CA, 94915-1616, US

(73) Assignee: MOTIA, INC., PASADENA, CA (US)

(21) Appl. No.: 11/627,149

(22) Filed: Jan. 25, 2007

Related U.S. Application Data
(60) Provisional application No. 60/763,275, filed on Jan. 30, 2006.

(51) Int. Cl. H04B 17/02

(52) U.S. Cl. 455/135

(57) ABSTRACT

A method for weight training for beamforming in handset terminals deployed in a system employing Frequency Division Duplexing and Time-Division Multiple Access (FDD/TDMA). Generally there is signal in time slots that are not destined for a certain terminal. During this time the receiver scans a beam around the terminal and measures received signal strength, determining the best beam angle and storing corresponding weights for transmission.

### CROSS REFERENCE TO RELATED APPLICATIONS

The present application claims the benefit of priority under 35 USC. sctn. 119(e) from U.S. provisional patent application 60/763,275 filing date Jan. 30, 2006 first named inventor Winters, titled: “WEIGHT TRAINING FOR BEAMFORMING IN GSM HANDSETS”, which is incorporated in its entirety by reference.

A related copending application having a common inventor and assignee is WIRELESS COMMUNICATION SYSTEM USING A PLURALITY OF ANTENNA ELEMENTS WITH ADAPTIVE WEIGHTING AND COMBINING TECHNIQUES application Ser. No. 10/732,003 filed Dec. 10, 2003.

### BACKGROUND OF THE INVENTION

In a wireless system using multiple antenna elements, the received signals can be combined to improve the performance of the receiver, providing both an array gain and a diversity gain against multipath fading. A variety of combining techniques can be used, including maximal ratio combining, whereby the receive weights are generated to maximize the output signal to noise ratio. Weight generation and combining can be done at RF (for example, using Granlund combining) or using digital signal processing after the individual antenna element signals have been downconverted to baseband and A/D converted. Note that RF combining has lower cost and uses less power than baseband combining (since fewer A/D's are needed), but digital combining can provide better performance in some cases and is generally required in multiple antenna systems using spatial multiplexing, such as the standard IEEE802.11 n.

For any system that employs Frequency Division Duplexing (FDD), the transmit frequency is different from the receive frequency. In this case, in a multiple antenna element system using combining, such as an adaptive array, the receive weights generally cannot be used as the transmit weights (as they can be in a time division duplex (TDD) system), since the multipath fading, array response, etc. may be different. Specifically, using the receive weights for transmission will result in a different antenna pattern for transmit than receive, which can result in reduced array gain. However, the transmit weights for the same transmit antenna pattern as the receive antenna pattern can be calculated from the receive weights with a knowledge of the transmit and receive frequency and the antenna element locations. However, if the difference in the transmit and receive frequencies is greater than the coherence bandwidth of the environment (as is typical in most FDD systems) the multipath fading is different at the two frequencies, and transmitting with the same antenna pattern for transmit as for receive will not provide a diversity gain against multipath on transmit. Furthermore, if the multipath fading is not averaged out, using the receive pattern (weights) for transmission can seriously degrade transmit performance, reducing the array gain as well.

Several methods have been proposed to calculate transmit weights in FDD systems. For example, in Code Division Multiple Access (CDMA) systems the power control bits from the base station can be used to adapt the transmit weights at the terminal [1]. This method can provide a gain on transmit that is similar to that on receive, i.e., both an array gain and diversity gain. However, the method only applies to CDMA, which uses power control bits.

In non-CDMA systems, a proposed method with time-varying fading is to first average the crosscorrelation matrix of the received desired signal over the fading, and then determine the eigenvector corresponding to the largest eigenvalue of this averaged matrix. This eigenvector then corresponds to the receive weights with the fading averaged out, i.e., the weights that provide array gain only (and no diversity gain). This eigenvector corresponds to a spatial antenna pattern that can then be translated from the receive to the transmit frequency to determine the transmit weights, e.g., by direct calculation or through a look-up table for antenna patterns pointing in a particular direction. This eigenbeamforming technique generates weights that then provide an array gain on transmit (but no diversity gain). However, this method may not work well when the terminal is slowly moving or stationary as the fading cannot be averaged in a reasonable time period. Furthermore, the approach is computationally intensive and generally requires digital signal processing of the received antenna signals, i.e., is not practical with RF combining. In these cases, an alternative approach would be to scan the receive antenna pattern to determine the receive antenna pattern averaged (or partially averaged) over the fading that provided the highest output signal to noise ratio, and translate that pattern to the transmit frequency. However, using a fixed antenna pattern with time-varying fading or scanning the receive beampattern during reception of the desired signal would result in a loss of diversity gain and degraded performance, as receive combining using, e.g., maximal ratio combining, is preferred.

Thus it can be appreciated that what is needed is a suitable method to compute the transmit weights to provide an array gain.

### SUMMARY OF THE INVENTION

The present invention relates to a scheme for weight training for transmission from a terminal in a system that employs Frequency Division Duplexing and Time-Division Multiple Access (TDMA). An embodiment of the invention applies to GSM or EDGE systems. It is noted that in such a system that employs Time-Division Multiple Access each terminal receives a signal in at least one of the time slots in each frame which consists of a plurality of time slots, e.g., 8 time slots in GSM and EDGE.

Thus, during each frame, there is generally a signal in time slots which are not destined for the terminal. The present invention activates a receiver during the time slots not destined for the terminal to receive signal while adjusting the weights to scan a beam around the terminal. The terminal measures the received signal strength as the beam is scanned, and then determines the beam pattern that corresponds to the strongest received signal.

The corresponding weights to be used for transmission that generate this beam pattern are then used for transmission, appropriately translated from the receive frequency. This can be done over several frames so that fading effects are partially averaged out.

This scheme then can provide an array gain, e.g. 3 dB with 2 antennas, 6 dB with 4 antennas, etc., on transmit, and determine the best beam pattern without degrading the performance of combining during desired signal reception.

[The invention will be more fully described by reference to the following drawings:

### BRIEF DESCRIPTION OF THE DRAWINGS

FIG. 1 is a block diagram of a transceiver.

FIG. 2 is a schematic diagram of a frame structure for GSM.

FIG. 3 is a schematic diagram of antenna beam patterns corresponding to the stored antenna weights.

FIG. 4 is a schematic diagram of a method to generate the directional antenna patterns.

FIG. 5 is a flowchart of the scanning process.

### DETAILED DESCRIPTION

Reference will now be made in greater detail to an embodiment of the invention, an example of which is illustrated in the accompanying drawings. Whenever possible, the same reference numerals will be used throughout the drawings and the description to refer to the same or like parts.

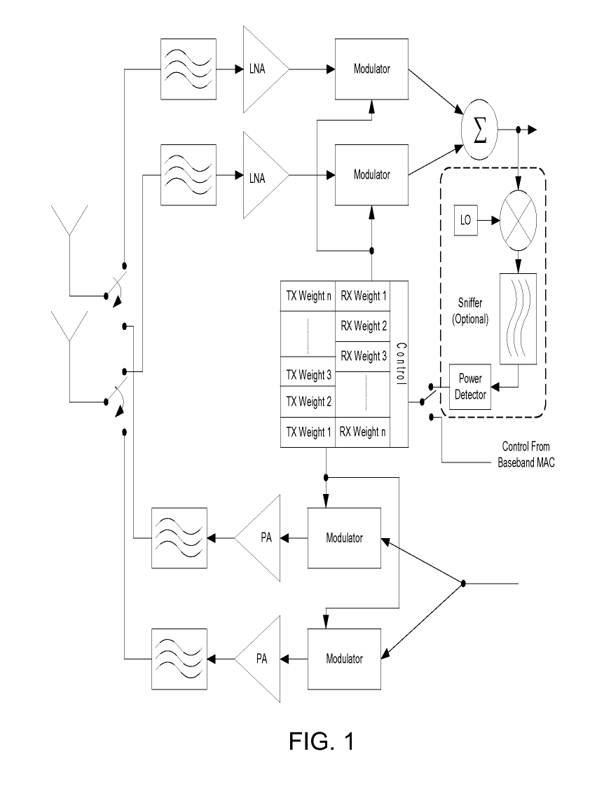

FIG. 1 shows a block diagram transceiver 10. The same antennas 12 are used for transmission and for reception, but are time multiplexed (as in conventional handset receivers). During at least one time slot when the signal is destined for the terminal, the receive weights are adapted to improve the output signal quality. In an embodiment, the weights are adapted for maximal ratio combining.

During at least one of the time slots when signals are destined for other terminals in the system (not necessarily every frame, though), the receive weights are adjusted to scan the receive antenna pattern and the received signal power for each pattern is measured by the transceiver power detector and recorded. In another embodiment, the received power can be measured by sniffer 20 (shown as optional in the figure). As discussed above, the pattern with the maximum signal power (averaged over a given period of time, e.g., averaged over the fading) is determined, and the corresponding transmit weights are then used for transmission. Note that the scanned antenna patterns could include directional beams where the angle of the beam is scanned over 360 degrees.

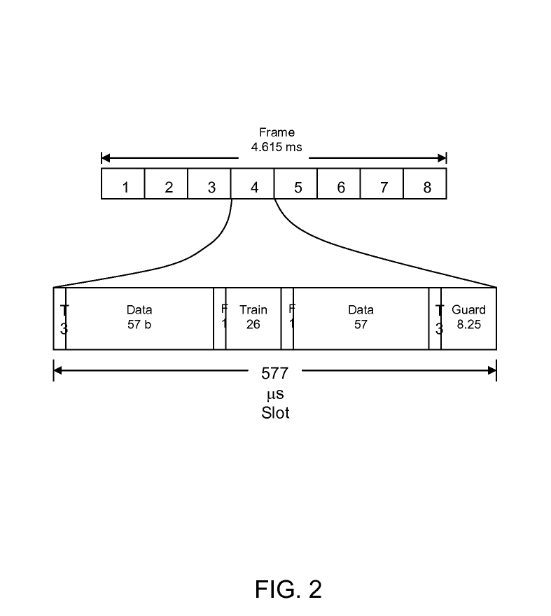

FIG. 2 shows the frame structure for a representative system that employs Frequency Division Duplexing and Time-Division Multiple Access, GSM, illustrating the 8 time slots in each frame, with one time slot for each user. In another embodiment, the EDGE data system, more than one time slot for each user may be assigned.

Transmit Pattern Generation:

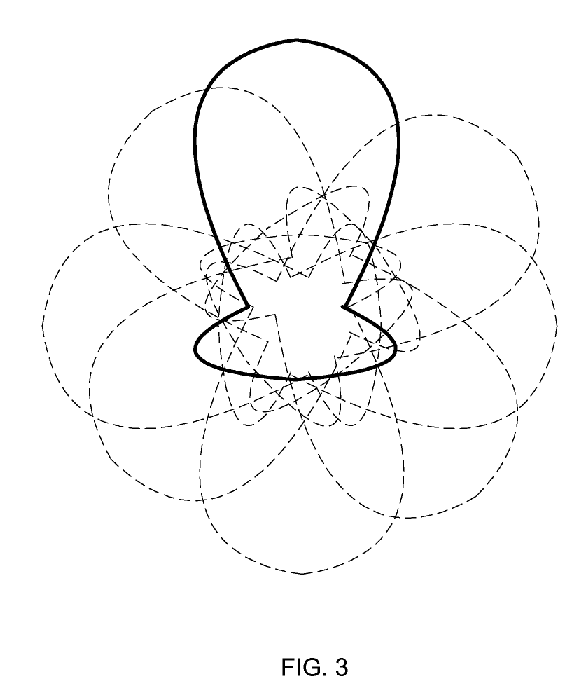

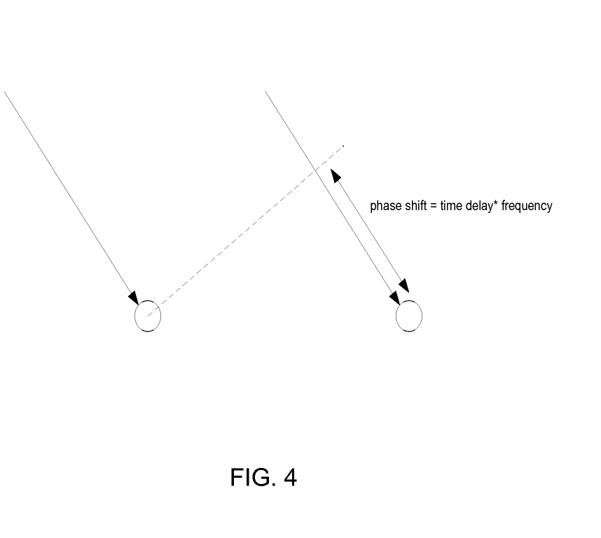

In an embodiment of the present invention, the antenna beam patterns corresponding to the stored antenna weights are shown in FIG. 3. Each antenna beam pattern peaks at a certain angle and is offset by a certain angle from the adjacent beam pattern. The method to generate a directional antenna pattern is illustrated in FIG. 4. To point the antenna pattern to a specific direction, the phase shift corresponding to the direction of arrival is computed by multiplying the frequency of operation with the time delay. The signals that arrive at different antenna elements are rotated by the corresponding phase shifts before these signals are added together.

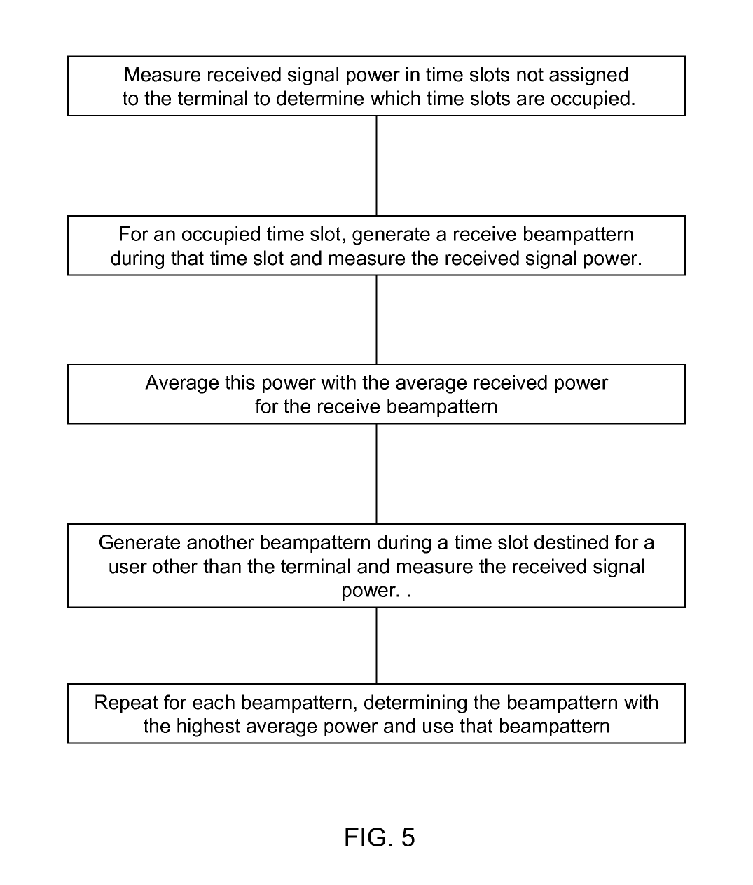

FIG. 5 shows a flowchart for the scanning process:
Step 1: Measure received signal power in time slots not assigned to the terminal to determine which time slots are occupied.
Step 2: For at least one of these occupied time slots, generate a receive beampattern during that time slot and measure the received signal power.
Step 3: Average this power with the average received power for the receive beam pattern.
Step 4: Generate another beampattern during a time slot destined for a user other than the terminal and measure the received signal power.
Step 5: Repeat steps 3 and 4 for each beampattern, periodically determining the beampattern with the highest average power and use that beampattern for transmission.

In one embodiment, the system control sweeps through all the antenna weight sequences during the initial beam pattern acquisition phase during timeslots for the signals destined to other terminals. By measuring the averaged received power for each antenna pattern, the pattern corresponding to the highest received power can be found. Note that by measuring the received power only during time slots assigned to other terminals, the beam scanning does not affect the reception of the desired signal during the terminal's assigned time slot. This permits the scanning for the optimum beam pattern to occur without degrading the terminal's performance, as it would if scanning was done during the terminal's assigned time slots.

In a second embodiment, the system control first measures averaged received power for two antenna patterns aimed approximately in opposing directions. If the first two measurements are approximately equal then the system control measures the average received power for two antenna patterns aimed 90 degrees offset. Otherwise, the system control measures averaged received power for two antenna patterns aimed 45 degrees off the strongest of the first two patterns.

At any point, transmission could occur using the corresponding weights for the antenna pattern having the highest received power so far found. The system further comprises a fine-adjustment phase comprising adjusting the pattern to alternate between adjacent patterns. The system control then directs a move to the right adjacent pattern or left adjacent pattern based on the following criteria:
If the received power corresponding to left pattern is higher than the received power corresponding to right pattern by a certain amount the system control causes a change of transmit pattern to the left pattern.
If the received power corresponding to right pattern is higher than the received power corresponding to left pattern by a certain amount the system control causes a change of transmit pattern to the right pattern.
If the difference between the received power corresponding to left pattern and the received power corresponding to right pattern is less than a certain amount, the system control causes no change of transmit pattern.

This process is then repeated. With this proposed approach of generating the transmit pattern, signals from different antenna elements are weighted equally in gain (but with different phase shifts). These weights then provide an array gain on transmit (but no diversity gain).

Received Pattern Generation

The received weights can be generated adaptively during the time slot destined for the terminal, e.g. for maximal ratio combining, to achieve both array gain and diversity gain. A method for implementing such antenna weight adaptation is described in U.S. patent application Ser. No. 10/732,003 filed Dec. 10, 2003 entitled “Wireless Communication System Using a Plurality of Antenna Elements with Adaptive Weighting and Combining Techniques” having a common inventor.

One good technique for weight generation for signal reception is maximal ratio combining. To achieve this, the received signal from each antenna element is phase-shifted such that the resultant signals from all antenna elements are in phase. In addition, the signal from each antenna is scaled in amplitude based on the square root of its received signal-to-noise ratio. All signals are then added and the resultant signal satisfies the maximal ratio combining criteria. For a system with only two antenna elements, a simplified method of achieving maximal ratio combining using the proposed implementation in FIG. 1 is to measure the received power of each antenna element separately. This can be done by setting all but one of the antenna weights to zero. Once the signal power for each antenna is measured, the magnitude of the corresponding antenna weight is scaled such that it is proportional to the square root of the corresponding received power. Once this is done, the phase of each antenna can be adjusted independently, using an iterative method similar to that described in the previous section to find the antenna weights corresponding to the highest received power. Note that with N antenna elements this adjustment only has to be performed on N−1 antenna elements, since only the relative phase differences change the output signal power. The resultant antenna weights are then the Maximal Ratio Combining weights. In order not to disturb the signal reception during the time slot assigned to the terminal, the acquisition phase can be done during time slots destined for other terminals. However the fine-adjustment phase can be performed during the time slot for the signal destined for the terminal.

In an embodiment, the measurement of received power may be performed on three antenna beam patterns separated by a range of 90 to 135 degrees, and the selection of an transmit antenna pattern 180 degrees from or opposite to the weakest of the three received beam patterns.

### CONCLUSION

The invention is a method for weight training for transmission from a terminal comprising the steps scanning a beam around a terminal, measuring the received signal strength as the beam is scanned, determining the beam pattern that corresponds to the strongest received signal, and using the corresponding weights for transmission. The beam is only scanned during time slots destined for other terminals so as to not affect the performance of the receiver during scanning.

The method further comprises repeating the scanning over several frames whereby fading effects are partially averaged out. The invention can be practiced in one embodiment by scanning the beam in angle by adjusting the received weights during the time slots for other users, and measuring the received signal power at each angle. The invention includes measuring the received power by one of a sniffer and a transceiver power detector.

The invention has the steps of determining the angle with the maximum signal power, and computing the corresponding transmit weights. The present invention includes the steps of stepping through all the antenna weight sequences and measuring the average receive power for each antenna pattern during the time slots for the signal destined for other terminals. A further improvement allows fine-adjustment by adjusting the pattern to alternate between the right and left adjacent patterns, and moving the transmit pattern to the left if the received power corresponding to the left pattern is higher than the received power corresponding to right pattern by a certain amount and moving the transmit pattern to the right pattern if the received power corresponding to a right pattern is higher than the received power corresponding to left pattern by a certain amount, and not changing the transmit pattern if the difference between the received power corresponding to left pattern and the received power corresponding to right pattern is less than a certain amount.

This process can be improved by iteration. The invention further comprises the steps of performing acquisition during the time slots destined for other terminals and performing fine-adjustment during the time slot for the signal destined for the terminal.

Better signal reception or battery life can be achieved with the system of the present invention. For transmit operation, since array gain can be achieved, the transmit power can be scaled back by the array gain. Thus it can be appreciated that power consumption of the system can be reduced.

It is to be understood that the above-described embodiments are illustrative of only a few of the many possible specific embodiments, which can represent the principles of the invention. Numerous and varied other arrangements can be readily devised in accordance with these principles without departing from the spirit and scope of the invention as fully claimed below.

What is claimed is:

1. A method for weight training reception and transmission beam forms in a frequency division duplex/time division multiple access handset terminal, the method comprising the steps of transmitting through a plurality of antennae adapted to a beam pattern with highest average received power and determining the beam pattern with highest average received power, wherein determining the beam pattern with highest average received power comprises the steps of selecting a terminal, measuring the received signal power during a time slot destined for a user other than the terminal, and averaging the received signal power with the average received power for the receive beam pattern, and comparing the average received power of each time slot, wherein measuring the received signal power comprises generating a receive beam pattern during an occupied time slot and measuring the signal power received during the time slot, wherein generating a receive beam pattern during an occupied time slot comprises the method of measuring received signal power in time slots not assigned to the terminal to determine which time slots are occupied.

2. The method of claim 1 further comprising the steps of sweeping through all the antenna weights stored for a certain antenna array and measuring the average received power for each antenna pattern wherein an antenna pattern corresponds to a plurality of weights, each associated with one element of an antenna array.

3. The method of claim 1 further comprising a method of fine-adjustment comprising adjusting a transmit antenna pattern to alternate between a left adjacent antenna pattern and a right adjacent antenna patterns wherein the method comprises one of causing a change of a transmit antenna pattern to the left adjacent antenna pattern if the received power corresponding to the left adjacent antenna pattern is higher than the received power corresponding to the right adjacent antenna pattern by a certain amount, causing a change of a transmit antenna pattern to the right adjacent antenna pattern if the received power corresponding to the right adjacent antenna pattern is higher than the received power corresponding to the left adjacent antenna pattern by a certain amount, and causing no change of a transmit antenna pattern if the difference between the received power corresponding to the right adjacent antenna pattern and the received power corresponding to the left adjacent antenna pattern is less than a certain amount.

4. The method of claim 1 further comprising the method of averaging the received signal power over several frames to compensate for fading effects before determining the beam pattern with highest average received power.

5. The method of claim 1 further comprising computing a transmit weight for each element of an antenna array wherein computing a transmit weight comprises the method of adding a phase shift to the receive weight wherein the phase shift is computed by multiplying a frequency of operation by a time delay.

6. The method of claim 1 further comprising the maximal ratio combining of received signals from each element of an antenna array.

7. The method of claim 1 further comprising the step of scaling back the transmit power by the array gain, whereby battery life is extended.

8. A method for achieving maximal ratio combining comprising the steps of setting all but one of the antenna weights to zero, measuring the signal power for each antenna, scaling the magnitude of the antenna weights proportional to the square root of the received power, and adjusting the phase of each antenna element during the time slots destined for other terminals and alternating between a left adjacent antenna beam pattern and a right adjacent antenna beam pattern during the time slot of the destined terminal.
